(19) United States
(12) Patent Application Publication
(10) Pub. No.: US 2015/0334064 A1
(43) Pub. Date: Nov. 19, 2015

(54) MULTIUSER WEB ONLINE COMMUNICATION TOOL WITH SECURE HANDSHAKE

(71) Applicant: Rob Roy Woodman, Davis, CA (US)

(72) Inventor: Rob Roy Woodman, Davis, CA (US)

(21) Appl. No.: 14/711,756

(22) Filed: May 13, 2015

Related U.S. Application Data
(60) Provisional application No. 61/992,834, filed on May 13, 2014.

(51) Int. Cl. H04L 12/58

(52) U.S. Cl. CPC H04L 51/046

(57) ABSTRACT

A method and system for centrally managing transaction displays and communication between users is disclosed. The system comprises a web interface displaying a unique presentation of the data submitted and generated by the user. A secure handshake of the present invention solves the problem of managing multiple requests between users and keeping all parties informed about the status of the potential agreement.

### CROSS-REFERENCE TO RELATED APPLICATIONS

This application claims the benefit of U.S. Provisional Application No. 61/992,834, filed May 13, 2014.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC

Not Applicable.

### FIELD OF THE INVENTION

The invention relates to computer-implemented transaction consummation. In particular, the invention relates to methods and systems for securely consummating online agreements via a digital Secure Handshake that ensures all parties are promptly notified of a transaction status.

### BACKGROUND

Web systems that require communication between users have become commonplace. However, when working within a multi-user environment, many online systems disregard common courtesy and efficient communication between its users. For example, regarding a confirmation or a simple agreement between two individuals, sometimes it is hard to know if the agreement was consummated or not. Worse yet, a user may think that a confirmation was made for a specific set of actions from one or more users, and that confirmation turns out to be disregarded. This leaves one or many users wondering, creating discontent with the confirmation of an agreement.

An example of a situation that could be encountered is that User #1, in a multi-user environment, sends a request to many users in this environment asking them if they agree for him/her, User #1, to stay at any of these other user's home/place. Many of the users may agree to User #1's request. Now, the issue is that many users think and/or perceive that User #1 will stay with them. Assume that ten users were contacted by User #1. Then User #1 decides to stay with only one of the ten users. As a result, nine other users are left hanging and thinking that they had an agreement for someone to visit their home, which never happens.

As can be seen, there is a need for a process that allows users to securely confirm that an agreement was made, to assist in avoiding users' frustration of not knowing if a requesting party has committed to a transaction or not with another party, and to ensure that all parties that have been contacted with an offer or request from an individual party will be promptly notified if the original requesting party consummates an agreement with a party.

### BRIEF SUMMARY OF THE INVENTION

In view of the foregoing described needs, an embodiment of the present invention includes a method and system for arranging agreements across the Internet between users where consummation of the agreement can be confirmed securely, confidentially and courteously. The system comprises a web interface supporting a software or web application that allows uses to make various arrangements with other users, and, allows one user to offer opportunities or request arrangements from a plurality of users, while still consummating only one agreement yet quickly and courteously notifying other candidates that the agreement has been executed with another party.

In an exemplary embodiment, a system and method for establishing a secure handshake between multiple parties according to the invention solves the problem of managing multiple requests and responses between multiple parties, thereby keeping multiple parties simultaneously informed as to the status of a potential agreement. More specifically, in one configuration, the network-implemented system and method for managing requests between users, the method comprises the steps of: (1) a first user sending a request across a network to a second user; (2) the second user electing to accept, decline, or ignore the request; (3) where the second user has accepted the request, the second user sending an acceptance across the network to the first user; and (4) the first user confirming the acceptance from the second user, finalizing the request. In another implementation, the request is made for users seeking an agreement for services, products, or a meeting. In another implementation, the network-implemented system and method further comprises the additional step of the system confirming and notifying the first user and the second user that the agreement is complete and fully accepted.

The system further supports a multi-user configuration, wherein the steps comprise: (1) the system allowing an initiating user to begin a transaction by sending a request for an agreement to two or more recipient users; (2) the system allowing the two or more recipient users to individually accept, decline, or ignore the request; (3) if any of the two or more recipient users have accepted the request, the system requiring the initiating user to further confirm or decline the request with one of the two or more recipient users, thus finalizing the request; and (4) the system allowing the initiating user to complete the transaction by declining or ignoring any requests accepted by the remaining two or more recipient users.

In another exemplary embodiment, the network-implemented system and method manages requests between multiple users over the network, the method comprising the steps of: (1) an initiating user beginning a secure handshake transaction by sending a request across the network for an agreement to two or more recipient users; (2) the two or more recipient users electing to individually accept, decline, or ignore the request; (3) where at least two recipient users elect to accept the request, the at least two recipient users notifying the system of the acceptance; (4) where the system has received an acceptance from the at least two recipient users, the system sending an acceptance notification for each of the at least two recipient users across the network to the initiating user; (5) the initiating user selecting the acceptance notification corresponding to one of the at least two recipient users; (6) the initiating user submitting a confirmation notice to the system; (7) the initiating user identifying non-selected recipient users; (8) the system sending the confirmation notice to the selected recipient user; and (9) the system sending a notice of rescission of the request to the non-selected recipient users, thus finalizing the request and completing the secure handshake transaction. In another implementation, the initiating user may complete the request by declining or ignoring any acceptance notification. In another implementation, the two or more recipient users are kept informed of the status of the transaction and whether the initiating user has finalized the request and completed the secure handshake transaction.

One skilled in the art would recognize that although described herein as supporting secure and courteous arrangements for online agreements between parties interesting in arranging visits in various cities across the world, the system is adaptable to support any online transaction that will benefit from the implementation of a less sterile transaction approach where the time, attention, feelings and considerations of other potential parties to a transaction are established as the highest priority.

### BRIEF DESCRIPTION OF THE DRAWINGS

These and other features, aspects and advantages of various embodiments of the present invention will become better understood with regard to the following description, appended claims, and accompanying drawings where:

FIG. 1 is a flowchart of the method associated with the Secure Handshake between two users, according to the present invention;

FIG. 2 is a flowchart of the method associated with the Secure Handshake between multiple users, according to the present invention;

FIG. 3 is an illustration of the structure for an exemplary computing environment supporting implementation of the system and method according to the present invention;

FIG. 4 is an illustration of the server of the exemplary computing environment of FIG. 1 in greater detail, according to the present invention.

FIG. 5 depicts a flowchart of the method by which a user initially accesses the system via a computer or mobile device, according to an exemplary embodiment of the invention;

FIG. 6 is an illustration of one version of the initial user interface page structure encountered by a user, according to the present invention;

FIG. 7 depicts an exemplary user registration page structure, according to the present invention;

FIG. 8 depicts an exemplary public interface page structure, according to the present invention;

FIG. 9 depicts an exemplary private interface page structure, according to the present invention; and,

FIG. 10 depicts an exemplary page structure for search and trip advisories, according to the present invention.

FIG. 11 is a structural diagram of the network and computing elements associated with the system and method, according to the present invention.

The accompanying drawings numbered herein are given by way of illustration only and are not intended to be limitative to any extent. Commonly used reference numbers identify the same or equivalent parts of the claimed invention throughout the accompanying drawings.

### DETAILED DESCRIPTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

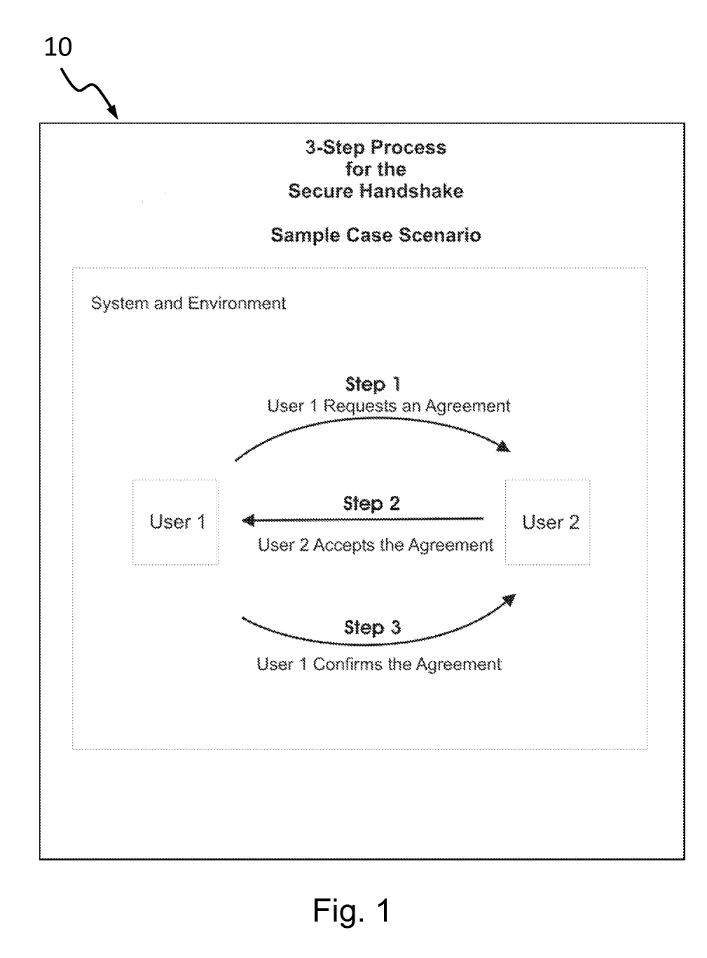

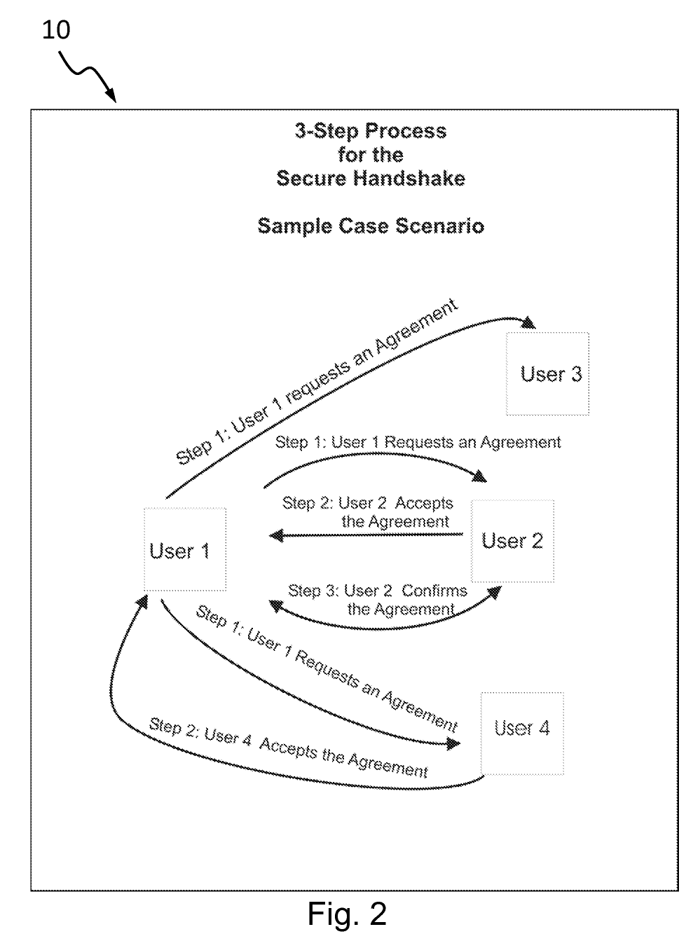

Referring now to FIG. 1 and FIG. 2, the method and system 10 of the present invention, hereinafter, also referred to as the Secure Handshake 10, addresses the problem of managing multiple requests and keeping every party involved in the requests informed as to the status of any potential agreement, whether accepted, declined or ignored. The Secure Handshake 10 manages all requests such that only one agreement is executed between a requesting user and one of the other registered users identified via a search query. In doing so, the Secure Handshake 10 avoids the need for requested users to track the status of a potential agreement.

In one aspect, where an interaction is only between two parties, User 1 and User 2, the Secure Handshake comprises three steps:

Step 1: A registered user, User 1, sends a request to another registered user, User 2, with a request for provision of an accommodation, product or service, i.e., an offer of an agreement.

Step 2: User 2 either accepts, declines or ignores the agreement request from User 1. If User 2 accepts the request to create an agreement with User 1, the method proceeds to Step 3.

Step 3: User 1, the user that initiated the request in Step 1, and then accepts, declines or ignores the proffered agreement from User 2. However, once the proffered acceptance of the agreement from User 2 is likewise acknowledged and accepted by User 1, i.e., User 1 has “confirmed” the agreement, Step 3 is complete and the agreement is fully accepted by both User 1 and User 2.

Upon completion of Step 3, where User 1 and User 2 have concluded and accepted the agreement, the user profiles for User 1 and User 2 will show the agreement as “Accepted.” Multiple completed agreements are tracked in a listing of “Accepted Agreements” for each user. The completion of the method of the Secure Handshake thereby creates a secure and confident feeling for User 1 and User 2 who now have reasonably strong assurance that the confirmed and executed agreement will be acted upon both parties to the agreement.

Referring now to FIG. 2, in a multi-user system, a use scenario involves a single user sending requests for an agreement to many users. The use scenario might also involve a user sending requests for an agreement to many users with specific dates and times specified in each request. Other scenarios can be accommodated by the method of the Secure Handshake 10.

In this case, User 1 has sent request to multiple other registered users: User 2, User 3 and User 4. Two or more users could accept User 1's request for an agreement. Here, User 2 and User 4 have both accepted the agreement from User 1. At this point, Step 2 of the three steps of the Secure Handshake 10 method is complete. The other users, Users 2, 3 and 4, would all receive a status message on their specific user dashboards/private interface. For an agreement to be fully implemented, User 1 has to complete all three Steps with any of the users that were originally contacted.

Still referring to FIG. 2, where Step 2 has been completed as evidence of acceptance of the agreement by one or more users, User 1 may confirm the agreement with only one of the users that accepted the agreement to complete the Secure Handshake 10. Upon confirmation by User 1, which completes Step 3, the Secure Handshake 10 causes all other users that had originally accepted the agreement to be notified that the offer of the agreement is rescinded and is no longer open and valid. Additionally, the Secure Handshake 10 causes all other users that have ignored the request from User 1 to be likewise notified that the offer of the agreement has been rescinded and is no longer open and valid.

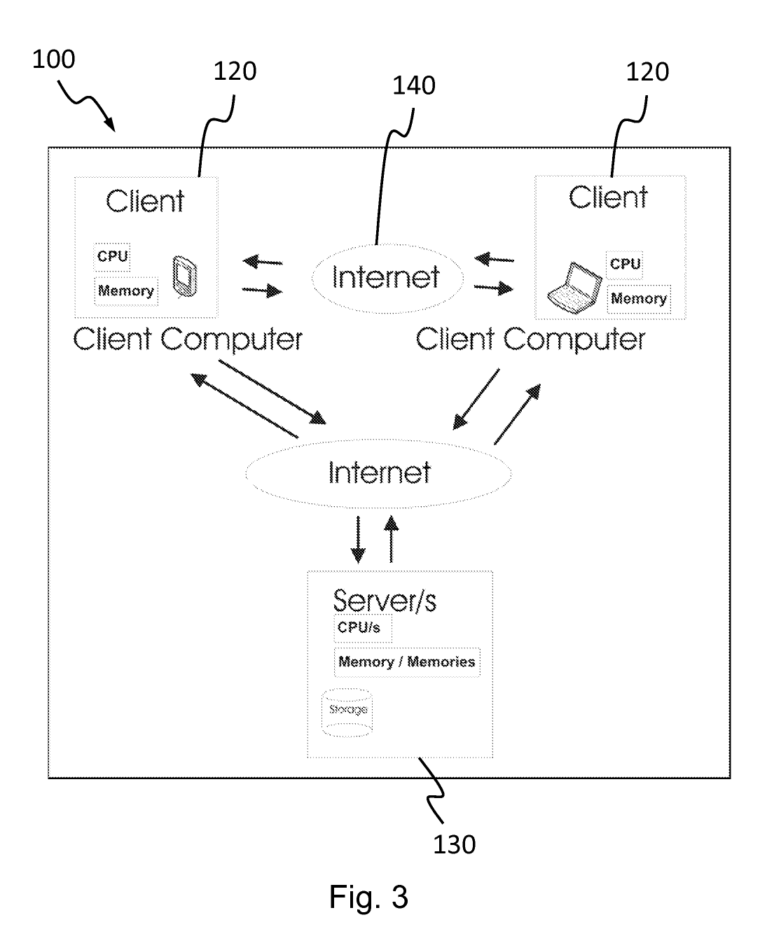

Referring to FIG. 3, an embodiment 100 of the present invention provides a method and system for centrally managing transactions and communication between two or more users client computers 120 via a browser across the Internet 140 in a client 120—server 130 configuration. The embodiment 100 enables users, as clients 120, to interact with each other in real time through web interfaces, chat, video conference, e-commerce transactions and other communication methods through web interfaces. The web interfaces display unique presentations of the data submitted and generated by a user. In one configuration, a central server 130 promulgates different web interfaces, leading a user to provide information, which can be evaluated by the system's central processes. The system causes various interfaces unique to each user to be displayed to support optimized and confident interaction between users in the system.

Embodiments of the method and system disclosed herein use a central server 130 or a cloud environment to store information. The method and system causes data to be processed most efficiently, either at the central server 130, in a cloud environment or at remote client computers 120. When processes are executed at the remote client computer 120, it saves costs and increases efficiency in serving multi-concurrency requests from client computer systems 120. Embodiments of the method and system disclosed herein provide centralized and non-centralized information processing capabilities.

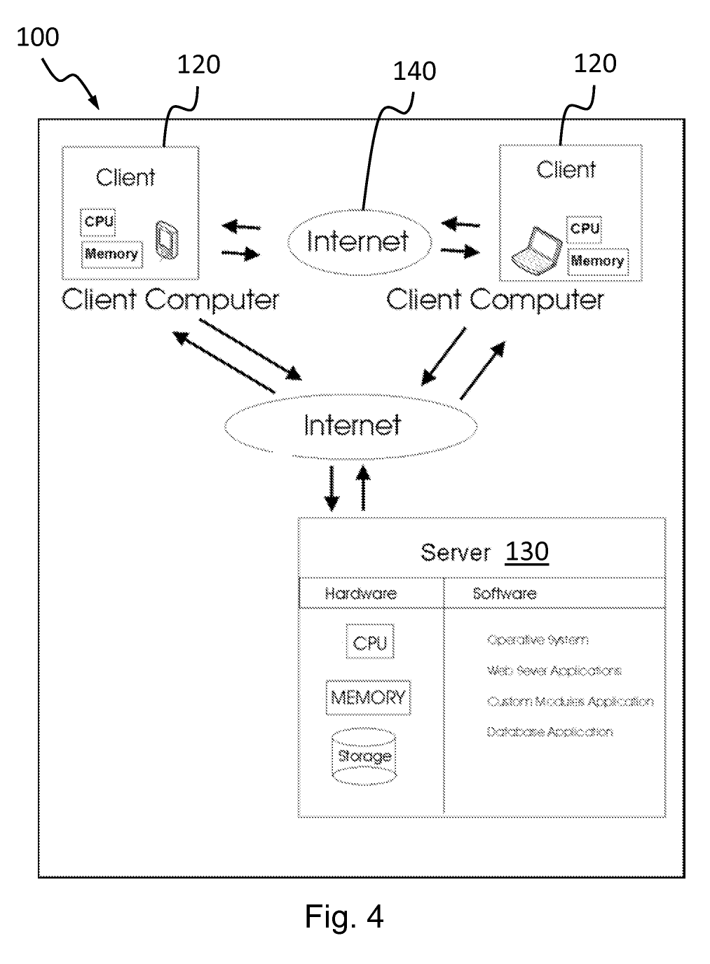

Referring to FIG. 4, module 100 comprises the operative system, including the software installed on a computer system. Module 101 comprises Web server applications, including the software applications installed on a computer system. Module 102 comprises custom module applications, including the custom software created as the invention disclosed herein. Module 103 comprises a database application, including the software application installed on the system capable of managing databases to store, edit and retrieve information. Module 104 comprises CPU: central processor unit in a computer system. Module 105 comprises memory, such as random access memory (RAM) or read-only memory (ROM) on a computer system.

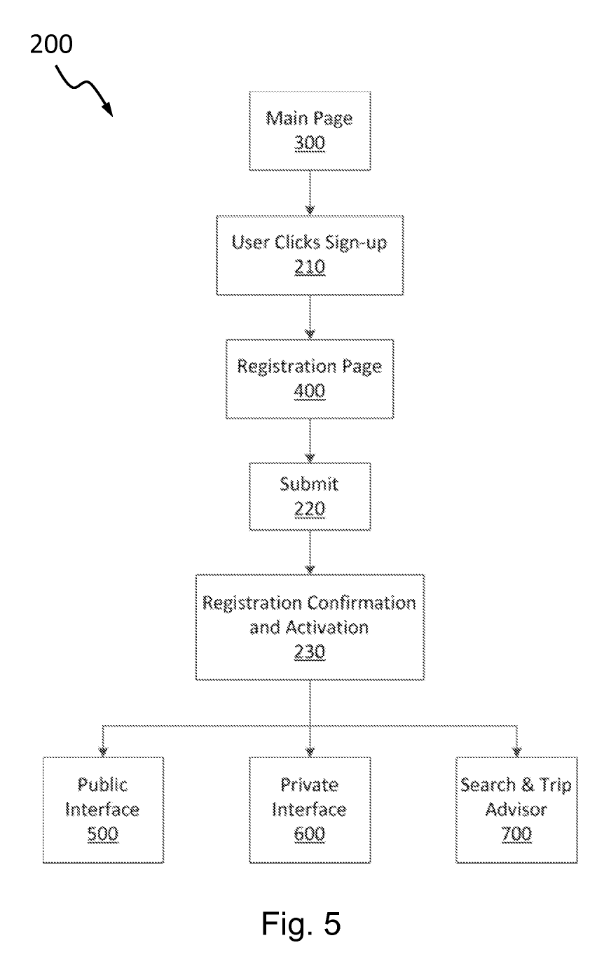

Referring to FIG. 5, a structural flowchart of the application 200 is illustrated. First, a user accesses a main page 300 of the application 200. The user then clicks Item (A) at step 210 to sign-up with the system 10. Upon clicking Item (A) Sign-up at step 210, the application 200 presents a registration page 400 to the user. The user will complete various forms and input fields on the registration page 400 and then at step 220 submit the registration page 400 with its inputted content to the application 200 operable on the system 100. The application 200 and system 100 will then confirm the registration and send an email at step 230 to confirm and activate the user's registration. Upon activation at step 230, the user will then be provided with additional hyperlinks on the main page 300 to access additional portions of the application 200. First, the user will have access to a public interface page 500. The user will also have access to a private interface page 600. Finally, the user will have access to a search and trip advisory page 700.

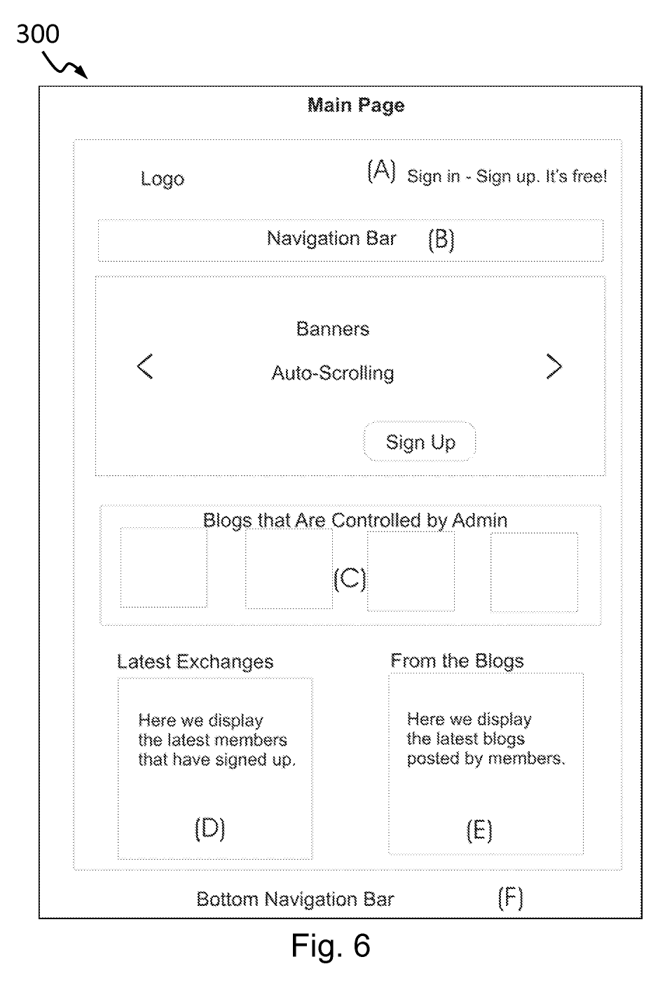

Referring now to FIG. 6, an exemplary structure for a main page 300 of the web application 200, according to embodiments of the method 10 (also known as the Secure Handshake method or Secure Handshake 10) and system 100 disclosed herein, is illustrated. The main page 300 provides an intuitive interface that allows a user to quickly and easily understand how the method 10 and system 100 delivery certain functionality to support the confident and courteous consummation of arrangements with other users by arranging agreements via the Secure Handshake method 10.

A user leverages the main page 300 to search and interact with other users in a highly efficient manner. A public interface page 500 created after a user signs up to use the system 100 include various aspects customized to the user's profile to deliver additional functionality, including real-time chat or video conferencing. The system 100 can be leveraged to transfer videos between users.

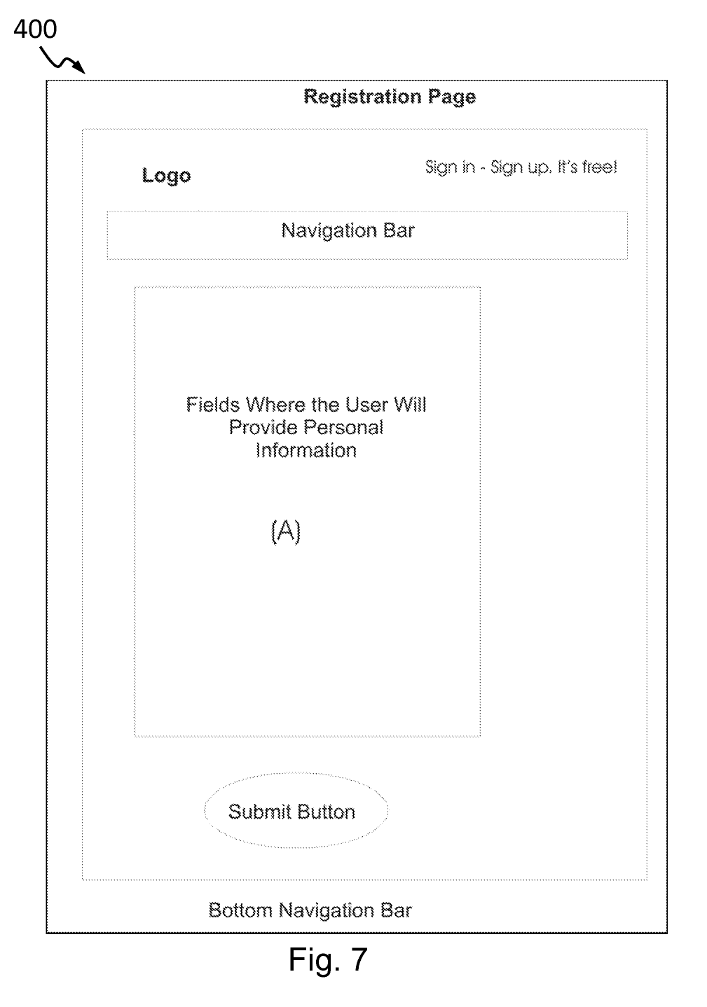

Referring now to FIG. 7, an exemplary structure for a registration page 400 of the application 200 is illustrated. To become an active participant in the system 100 and its associated web application 200, a user completes the process of registration by submitting certain personal information. Typical information to be provided to the system 100 via the registration page 400 includes data such as “First Name, Last Name, Email Address, Username, Password, Date of Birth, Country, State, and City.” Country, State and City can be auto populated from a database operable on the server. Each user enters and submits the required data to become a member of the site. The system 100 then performs a real time check against the database 130 to determine if any other registered user is already using the same username and/or email. During registration, the system will notify the user, in real time, with a confirmation as each field is successfully completed. Then, the user may submit the completed registration page/form 400 to the system 100 for requested approval.

Once a user has successfully completed the requested fields during registration, and submitted 220 the completed information to the system 100, the user is presented with a screen informing the user that an email to confirm registration was sent to the user's email address. The email sent to the user contains a hyper-link that must be actuated to complete the registration of the use with the system 100 for access via the web application. A typical message displayed to the user would be, for example “Check your email and click on activation link to activate your account”. Data provided during registration causes the system 100 to customize the public web interface presented to the registered user, which includes a user ID and username. Each interface presented to a user is driven by software processes executed on the server, creating queries to the central database.

Certain data is input when a user creates a reference profile. A unique web link may be provided to the user. Exemplary user input fields can include:

First Name, Last Name—this data is also required to enter the site and is displayed on the user profile and elsewhere on the site;

E-mail—the system 100 will send personalized notifications (account verification, notification of new messages, etc.) to the user's specified e-mail address. Each user will manage what personal data is displayed publicly on the user's profile.

Password—the password established by a user will establish first level security for access to the user's information in the system 100 to help prevent unauthorized access.

In one embodiment, the web application allows users to keep providing more personal data to share with the general public, if they decide to do so.

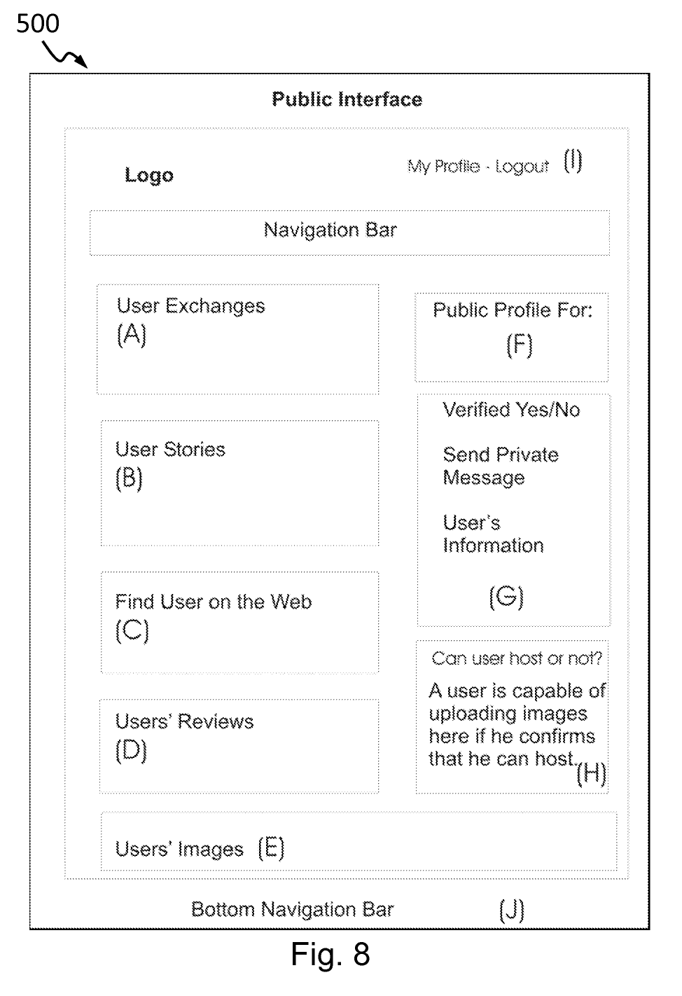

Referring to FIG. 8, an exemplary structure for a public interface page of a web application, according to embodiments of the method and system 100 disclosed herein, is illustrated. The system 100 generates the public interface based on information previously loaded and stored in the system 100 through users' computers with browsers. The public interface is browser-based and customizable to address user activity and configuration preferences expressed by each user. The system 100 causes the server to respond to requests from client computers and mobile devices in an expedited fashion, emphasizing real-time response. The system 100 causes a unique interface with many functional capabilities to be generated for each user of the system 100.

Once a user enters initial personal information and the information is stored in the database 130 in the central system 100, the user can update his or her current information and/or provide more information. The user can upload pictures and information about the pictures. The system 100 provides each user with both a public interface 500 and private interface 600.

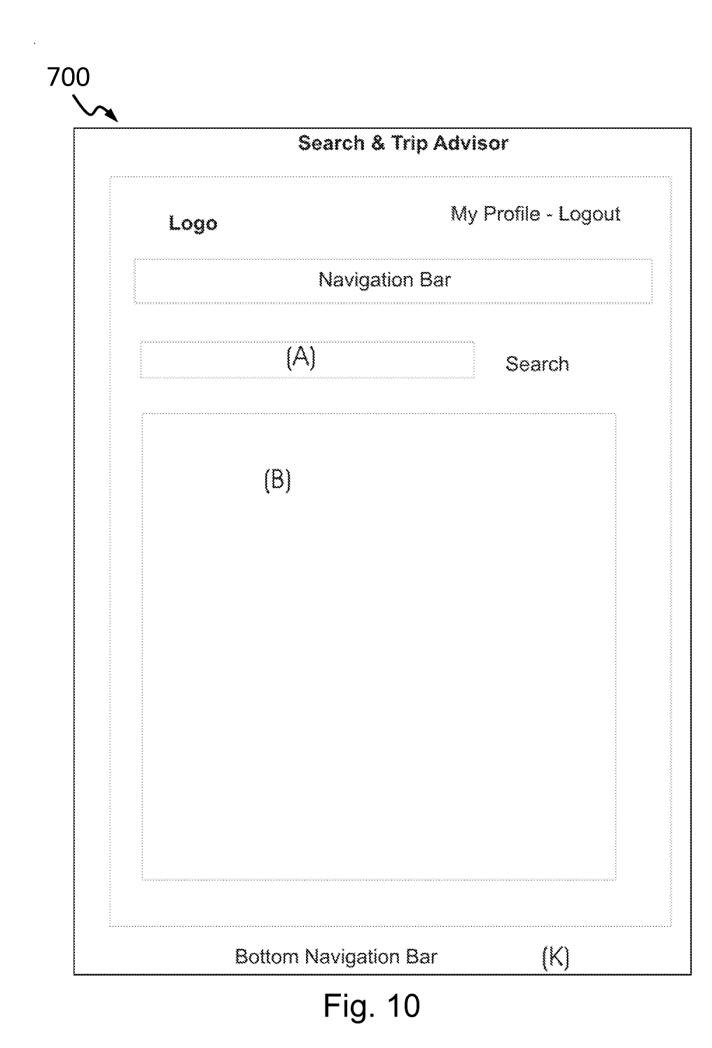

Referring to FIG. 10, an illustration of an exemplary structure for the search and trip advisor interface is provided. The system 100 allows a user to execute search queries, which will ultimately display content of public web interfaces of other users that match the search query. A user can find other users by entering a desired city, state and country, in the search box. The system 100 will cause the user to be provided with a brief overview of the existing registered users whose profiles match the city, state and country via the user's public interface page.

When a user is logged in to the system 100, a cookie ID is stored on the user's client computer, which is matched with an ID in the database, uniquely identifying the user as further open to communicating via his web interface.

Once a user has performed a search, the user can select from the list of other registered users and request an agreement with at least one of the list of users. For example, a user searching for other registered users in different cities might be interested in creating various agreements with one or more of those found users.

For example, a user wishing to visit a particular city could request the opportunity to stay at another registered user's home in that city while visiting. To maximize the likelihood of identifying a registered user willing to accommodate the searching user's request, the searching user might elect to submit requests to multiple parties. However, two or more of the requested registered users might respond affirmatively and be willing to enter into an agreement with the requesting user. Consequently, it is desirable to have a system 100 and method to avoid complications in this scenario, and, to ensure that all parties engaged are dealt with in a timely and courteous manner.

It should be understood that the system 100 can be used in any situation in which a user makes the same request of many other users seeking an agreement for services or products or a meeting. In any situation where a user will make a choice among many possibilities, this system 100 will finalize the understanding of who will eventually provide those services or products or meetings.

It should also be understood that the system 100 may be implemented using a variety of technologies. The methods and techniques may be implemented in software already executing itself on a computer system, or they may be implemented on hardware utilizing either a combination of microprocessors or other specially designed, application-specific integrated circuits, programmable logic devices, or various combinations thereof. Suitable computer-readable media may include random access memory (RAM), for example, and/or non-volatile memory like ROM, disk, CD, DVD.

Referring now to FIG. 6, on the Main Page, item (A) depicts a section where a user can Sign In or Sign up. When a user clicks “sign in”, the user is presented with a web page where the user can input a username or email and password. Once the system 100 verifies that the username and/or email and password is correct and matches the record in the database, then the user is signed in into the system 100. Once the user is signed in, the user can access the private profile section of the system 100. Item (B) depicts a navigation bar that includes links to many web pages. Some of the links included in the navigation bar lead the user to the sign in page, asking for username or email and password to access the system 100. If the user is already logged in to the system 100, the navigation bar shows links to other areas of the application that are not accessible by users that have not logged in to the system 100. Item (C) depicts a section of the main page 300 comprising blogs that are controlled by a system administrator. Each blog area in this section contains a thumbnail picture and short description that can be clicked, taking a user to another web page with a longer description and more pictures about the blog clicked. Item (D) depicts a section displaying the names of the latest users that have registered/signed up in the system 100. Typically, a picture of the individual along with the first and last name is shown. Item (E) depicts a section with a couple of the latest blogs posted by existing registered users.

Referring now to FIG. 7, the registration page 400, item (A) depicts a section where a user is required to enter personal information to register with the system 100. Typical data requested includes, for example, “First Name, Last Name, Email Address, Username, Password, Date of Birth, Country, State, and City.” Country, State and City may be auto populated from the server database based on user's provision of a zip code.

Referring now to FIG. 8, various features of the public Interface page 500 are described. Item (A) depicts a section where interactions and agreements between users may be displayed related to the user that visits someone else's profile. Item (B) depicts a section for display of the user's stories or blogs. Item (C) depicts a section where users display links or places where they can be found on the web. Item (D) depicts a section for listing user reviews. Item (E) depicts a section where a user displays his/her pictures uploaded onto the system 100 of the present invention. Item (F) depicts a section where the user first name and last name plus a picture of the user is displayed. Item (G) depicts a section where a user can be contacted via a private message. In this section, only the user's public data is seen. Item (H) depicts a section where the user states his wishes to host (or not) another user. This section is capable of showing images of the place that the user is offering to host another user. Item (I) depicts a section that a user can click to return to his private profile or logout from the system 100. Item (J) depicts a section referred as the bottom navigation bar where multiple hyperlinks may be displayed that lead to other webpages with information.

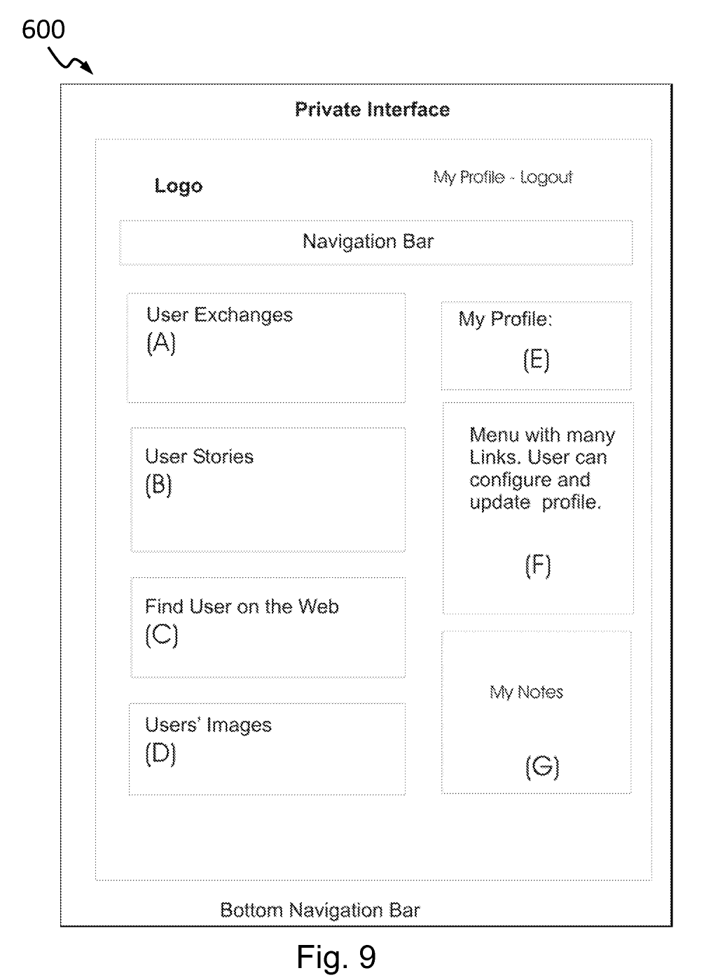

Referring now to FIG. 9, item (A) depicts a section where agreements between users are shown. A user accesses this section (A) to request agreements or respond to requests for agreements. In essence, Section (A) functions as the key access point for implementation of the Secure Handshake method 10. Item (B) depicts a section where a user can post and edit his stories for all members in the system 100 to see. Item (C) depicts a section where the user can post web addresses, known as uniform resource locators (URLs), of different websites where this user can be found. For example, a user can list many social media links where he can be found on the web for users to visit an external website. Item (D) depicts a section where the user can upload pictures and include a brief description about the pictures for all users in the system 100 to see. Item (E) depicts a section where the users can edit their profile information, change his/her password, send and receive emails, keep track of dates and events in a personal calendar and configure security settings allowing certain information not to be disclosed publicly. Item (F) depicts a section where the user First Name and last name are displayed as well with his/her personal photo if any. If the user did not upload a picture, an avatar picture is displayed. Item (G) depicts a section where the user can edit his/her profile information, change his/her password, send and receive emails, keep track of dates and events in a personal calendar and configure security settings allowing certain information not to be disclosed publicly.

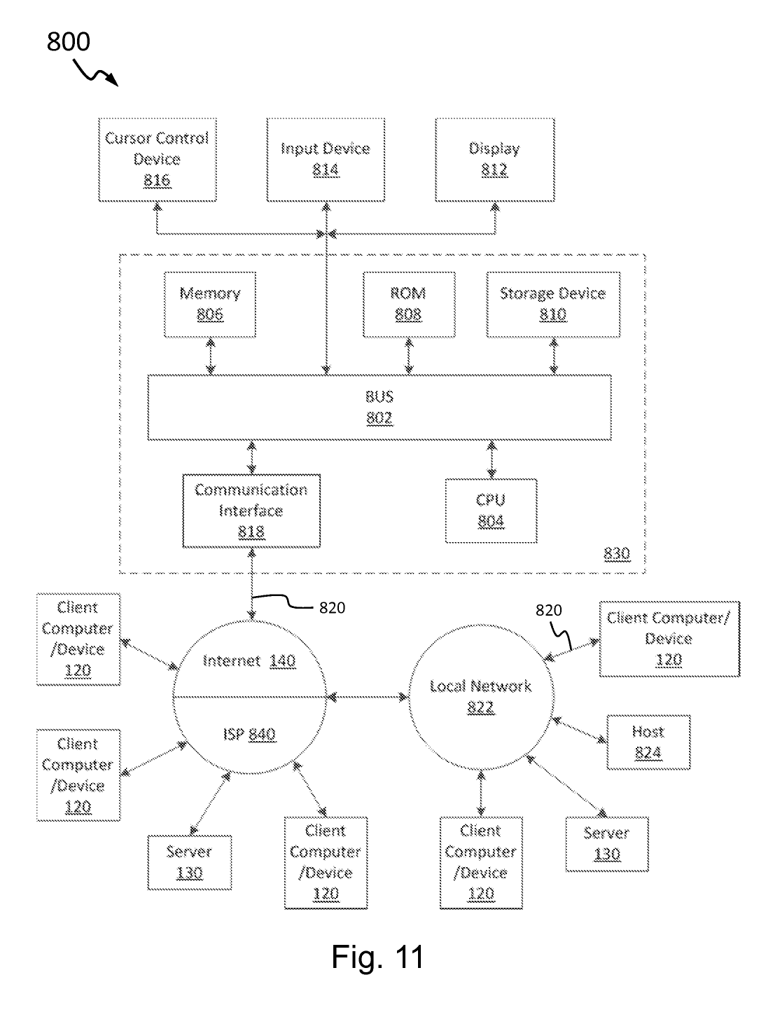

Referring now to FIG. 11, the system 100 includes one or more client devices 120 such as consumer electronics devices, computers, etc., connected to one or more server computing systems 130. A server 130 includes a bus 802 or other communication mechanism for communicating information, and a processor (CPU) 804 coupled with the bus 802 for processing information. The server 130 also includes a main memory 806, such as a random access memory (RAM) or other dynamic storage device, coupled to the bus 802 for storing information and instructions to be executed by the processor 804. The main memory 806 also may be used for storing temporary variables or other intermediate information during execution or instructions to be executed by the processor 804. The server computer system 130 further includes a read only memory (ROM) 808 or other static storage device coupled to the bus 802 for storing static information and instructions for the processor 804. A storage device 810, such as a magnetic disk or optical disk, is provided and coupled to the bus 802 for storing information and instructions. The bus 802 may contain, for example, thirty-two address lines for addressing video memory or main memory 806. The bus 802 can also include, for example, a 32-bit data bus for transferring data between and among the components, such as the CPU 804, the main memory 806, video memory and the storage 810. Alternatively, multiplex data/address lines may be used instead of separate data and address lines.

The server 130 may be coupled via the bus 802 to a display 812 for displaying information to a computer user. An input device 814, including alphanumeric and other keys, is coupled to the bus 802 for communicating information and command selections to the processor 804. Another type or user input device comprises cursor control 814, such as a mouse, a trackball, or cursor direction keys for communicating direction information and command selections to the processor 804 and for controlling cursor movement on the display 812.

According to one embodiment of the invention, the functions of the invention are performed by the processor 804 executing one or more sequences of one or more instructions contained in the main memory 806. Such instructions may be read into the main memory 806 from another computer-readable medium, such as the storage device 810. Execution of the sequences of instructions contained in the main memory 806 causes the processor 804 to perform the process steps described herein. One or more processors in a multi-processing arrangement may also be employed to execute the sequences of instructions contained in the main memory 806. In alternative embodiments, hard-wired circuitry may be used in place of or in combination with software instructions to implement the invention. Thus, embodiments of the invention are not limited to any specific combination of hardware circuitry and software.

The terms “computer program medium,” “computer usable medium,” “computer readable medium”, and “computer program product,” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network that allow a computer to read such computer readable information. Computer programs (also called computer control logic) are stored in main memory and/or secondary memory. Computer programs may also be received via a communications interface. Such computer programs, when executed, enable the computer system to perform the features of the present invention as discussed herein. In particular, the computer programs, when executed, enable the processor multi-core processor to perform the features of the computer system. Accordingly, such computer programs represent controllers of the computer system.

Generally, the term “computer-readable medium” as used herein refers to any medium that participated in providing instructions to the processor 804 for execution. Such a medium may take many forms, including but not limited to, non-volatile media, volatile media, and transmission media. Non-volatile media includes, for example, optical or magnetic disks, such as the storage device 810. Volatile media includes dynamic memory, such as the main memory 806. Transmission media includes coaxial cables, copper wire and fiber optics, including the wires that comprise the bus 802. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave as described hereinafter, or any other medium from which a computer can read.

Various forms of computer readable media may be involved in carrying one or more sequences of one or more instructions to the processor 804 for execution. For example, the instructions may initially be carried on a magnetic disk of a remote computer. The remote computer can load the instructions into its dynamic memory and send the instructions over a telephone line using a modem. A modem local to the server 130 can receive the data on the telephone line and use an infrared transmitter to convert the data to an infrared signal. An infrared detector coupled to the bus 802 can receive the data carried in the infrared signal and place the data on the bus 802. The bus 802 carries the data to the main memory 806, from which the processor 804 retrieves and executes the instructions. The instructions received from the main memory 806 may optionally be stored on the storage device 810 either before or after execution by the processor 804.

The server 130 also includes a communication interface 818 coupled to the bus 802. The communication interface 818 provides a two-way data communication coupling to a network link 820 that is connected to the worldwide packet data communication network now commonly referred to as the Internet 828. The Internet 828 uses electrical, electromagnetic or optical signals that carry digital data streams. The signals through the various networks and the signals on the network link 820 and through the communication interface 818, which carry the digital data to and from the server 130, are exemplary forms or carrier waves transporting the information.

In another embodiment of the server 130, interface 818 is connected to a network 822 via a communication link 820. For example, the communication interface 818 may be an integrated services digital network (ISDN) card or a modem to provide a data communication connection to a corresponding type of telephone line, which can comprise part of the network link 820. As another example, the communication interface 818 may be a local area network (LAN) card to provide a data communication connection to a compatible LAN. Wireless links may also be implemented. In any such implementation, the communication interface 818 sends and receives electrical electromagnetic or optical signals that carry digital data streams representing various types of information.

The network link 820 typically provides data communication through one or more networks to other data devices. For example, the network link 820 may provide a connection through the local network 822 to a host computer 324 or to data equipment operated by an Internet Service Provider (ISP) 826. The ISP 826 in turn provides data communication services through the Internet 828. The local network 822 and the Internet 828 both use electrical, electromagnetic or optical signals that carry digital data streams. The signals through the various networks and the signals on the network link 820 and through the communication interface 818, which carry the digital data to and from the server 130, are exemplary forms of carrier waves transporting the information.

The server 130 can send/receive messages and data, including e-mail, program code, through the network, the network link 820 and the communication interface 818. Further, the communication interface 818 can comprise a USB/Tuner and the network link 820 may be an antenna or cable for connecting the server 130 to a cable provider, satellite provider or other terrestrial transmission system for receiving messages, data and program code from another source.

The example versions of the invention described herein may be implemented as logical operations in a distributed processing system such as the system 100 including the servers 130. The logical operations of the present invention may be implemented as a sequence of steps executing in the server 130, and as interconnected machine modules within the system 100. The implementation is a matter of choice and can depend on performance of the system 100 implementing the invention. As such, the logical operations constituting said example versions of the invention are referred to for e.g., as operations, steps or modules.

Similar to a server 130 described above, a client device 120 can include a processor, memory, storage device, display, input device and communication interface (e.g., e-mail interface) for connecting the client device to the Internet 828, the ISP 826, or LAN 822, for communication with the servers 130.

The system 100 can further include computers (e.g., personal computers, computing nodes) 120 operating in the same manner as client devices 301, wherein a user can utilize one or more computers 120 to manage data in the server 130.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

It should be understood, of course, that the foregoing relates to exemplary embodiments of the invention and that modifications may be made without departing from the spirit and scope of the invention as set forth in the following claims.

The present invention has been particularly shown and described with respect to certain preferred embodiments and features thereof. However, it should be readily apparent to those of ordinary skill in the art that various changes and modifications in form and detail may be made without departing from the spirit and scope of the inventions as set forth in the appended claims. The inventions illustratively disclosed herein may be practiced without any element which is not specifically disclosed herein.

I claim:

1. A network-implemented system and method for managing requests between users, the method comprising the steps of:
(a) a first user sending a request across a network to a second user;
(b) the second user electing to accept, decline, or ignore the request;
(c) where the second user has accepted the request, the second user sending an acceptance across the network to the first user; and
(d) the first user confirming the acceptance from the second user, finalizing the request.

2. The network-implemented system and method of claim 1, wherein the request is made for users seeking an agreement for services, products, or a meeting.

3. The network-implemented system and method of claim 2, further comprising the additional step of the system confirming and notifying the first user and the second user that the agreement is complete and fully accepted.

4. A network-implemented system and method for managing requests between multiple users over the network, the method comprising the steps of:
(a) an initiating user beginning a secure handshake transaction by sending a request across the network for an agreement to two or more recipient users;
(b) the two or more recipient users electing to individually accept, decline, or ignore the request;
(c) where at least two recipient users elect to accept the request, the at least two recipient users notifying the system of the acceptance;
(d) where the system has received an acceptance from the at least two recipient users, the system sending an acceptance notification for each of the at least two recipient users across the network to the initiating user;
(e) the initiating user selecting the acceptance notification corresponding to one of the at least two recipient users;
(f) the initiating user submitting a confirmation notice to the system;
(g) the initiating user identifying non-selected recipient users;
(h) the system sending the confirmation notice to the selected recipient user; and
(i) the system sending a notice of rescission of the request to the non-selected recipient users, thus finalizing the request and completing the secure handshake transaction.

5. The network-implemented system and method of claim 4, wherein the initiating user completes the request by declining or ignoring any acceptance notification.

6. The network-implemented system and method of claim 4, wherein the two or more recipient users are kept informed of the status of the transaction and whether the initiating user has finalized the request and completed the secure handshake transaction.
